(19) United States
(12) Patent Application Publication
(10) Pub. No.: US 2009/0111333 A1
(43) Pub. Date: Apr. 30, 2009

(54) ELECTRICAL CONNECTOR FOR COMPUTER PERIPHERAL DEVICE

(75) Inventors: Ding-Teng Hou, Sanchung City (TW); Huei-Jen Chang, Sanchung City (TW)

Correspondence Address: RABIN & Berdo, PC, 1101 14TH STREET, NW, SUITE 500, WASHINGTON, DC, 20005, US

(73) Assignee: KYE SYSTEMS CORP., Taipei Hsien (TW)

(21) Appl. No.: 12/199,197

(22) Filed: Aug. 27, 2008

(30) Foreign Application Priority Data
Oct. 31, 2007 (TW) 096140906

(51) Int. Cl. H01R 9/22

(52) U.S. Cl. 439/709

(57) ABSTRACT

An electrical connector of a computer peripheral device has an insulating base having a plurality of slots spaced along the side of the insulating base and each of the slots having a conductive terminal. Each of the conductive terminals has a first end and a second end. The first end protrudes up from the insulating base for electrically contact to a printed circuit board which is located above the insulating base within the computer peripheral device. The second end extends away from the insulating base for electrically coupling to a cable of the computer peripheral device. Therefore the electrical connector facilitates the connection between the printed circuit board and the cable of the computer peripheral device.

### BACKGROUND OF THE INVENTION

1. Field of the Invention

The present invention relates to an electrical connector, especially to an electrical connector that facilitates connecting a printed circuit board of a computer peripheral device with a cable.

2. Description of the Related Art

Computer peripheral devices are indispensable for operating a computer. A computer peripheral device, like a mouse, may comprise a base, a printed circuit board and a cable. The printed circuit board is mounted on the base and has a plurality of signal contacts formed on a surface of the printed circuit board. The cable has a plurality of terminals formed on an end of the cable and being respectively soldered on the signal contacts of the printed circuit board to be electrically connected to the printed circuit board.

However, the solder may deform easily due to high temperature, man-made errors or low precision, and then weaken connection between the printed circuit board and the cable and finally lead to product failure and consumption of time and cost.

To overcome the shortcomings, the present invention provides an electrical connector to mitigate or obviate the aforementioned problems.

### SUMMARY OF THE INVENTION

The main objective of the invention is to provide an electrical connector of a computer peripheral device that facilitates connecting a printed circuit board of the computer peripheral device with a cable.

The electrical connector in accordance with the present invention comprises an insulating base having a plurality of slots spaced along the side of the insulating base and each of the slots having a conductive terminal. Each of the conductive terminals has a first end and a second end. The first end protrudes up from the insulating base for electrically contact to a printed circuit board which is located above the insulating base within the computer peripheral device. The second end extends away from the insulating base for electrically coupling to a cable of the computer peripheral device. Therefore the electrical connector facilitates the connection between the printed circuit board and the cable of the computer peripheral device.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector in accordance with the present invention;

FIG. 2 is a perspective operational view of assembling a printed circuit board, a base, a cover and the electrical connector as in FIG. 1;

FIG. 3 is a side view in partial section of a combination of a printed circuit board, a base, a cover and the electrical connector as in FIG. 1; and

FIG. 4 is a perspective view of a combination of a printed circuit board, a base and the electrical connector as in FIG. 1; and

FIG. 5 is a top view of a cable for connecting the electrical connection as in FIG. 1.

### DETAILED DESCRIPTION OF THE PREFERRED EMBODIMENTS

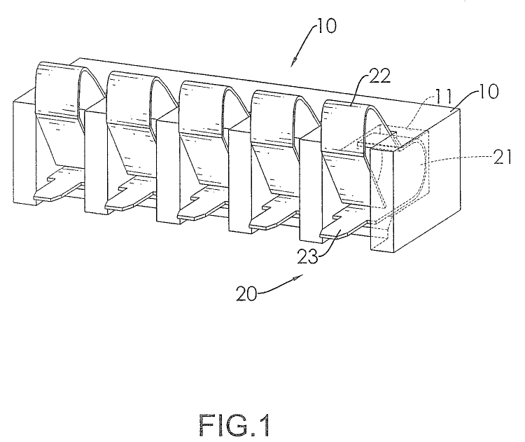

With reference to FIG. 1, an electrical connector (1) in accordance with the present invention comprises an insulating base (10).

The insulating base (10) has a side and a plurality of slots (11) and may be a rectangular solid. The slots (11) are spaced along the side of the insulating base (10). Each of the slot (11) has a conductive terminal (20).

Each of the conductive terminals (20) are metallic and bent and has a first end protruding up from the insulating base (10) and a second end extending away from the insulating base (10) and may have a mounting portion (21), a contact portion (22) and a pin portion (23). The mounting portion (21) is U-shaped and mounted in a corresponding slot (11) of the insulating base (10). The contact portion (22) is formed on and extends up from a top end of the mounting portion (21) and protrudes out from the insulating base (10) and may be implemented as the first end of the conductive terminal (20). The pin portion (23) is formed on and extends forward from a bottom end of the mounting portion (21) under the contact portion (22) and may be implemented as the second end of the conductive terminal (20).

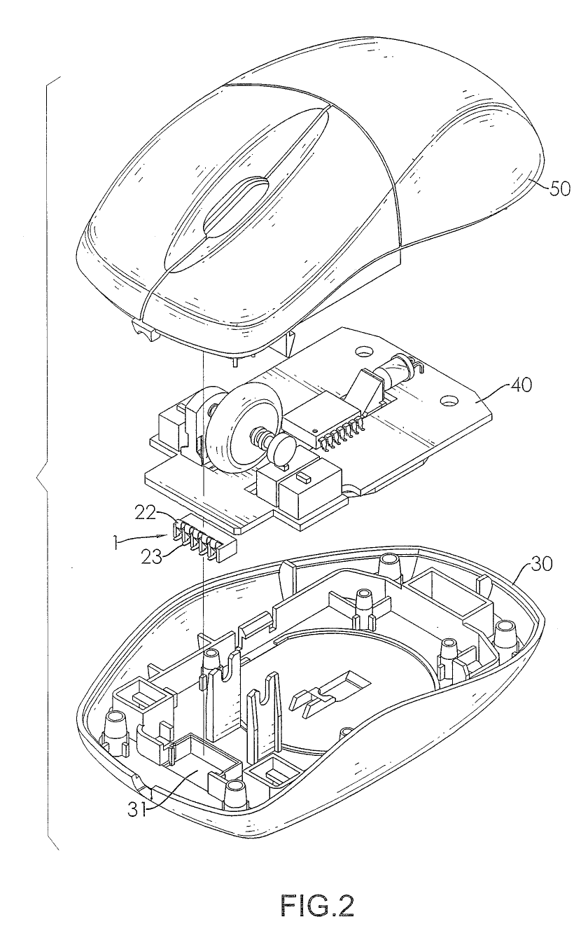

With further reference to FIG. 2, the electrical connector (1) is implemented as a component of a computer peripheral device. The computer peripheral device may be a mouse and further has a base (30), an electrical connector (1), a printed circuit board (40) and a cover (50) in addition to the electrical connector (1).

The base (30) has a mounting slot (31). The mounting slot (31) corresponds to and receives the insulating base (10) of the electrical connector (1) and has a front opening exposing the side of the insulating base (10) and the pin portions (23) of the conductive terminals (20) of the electrical connector (1).

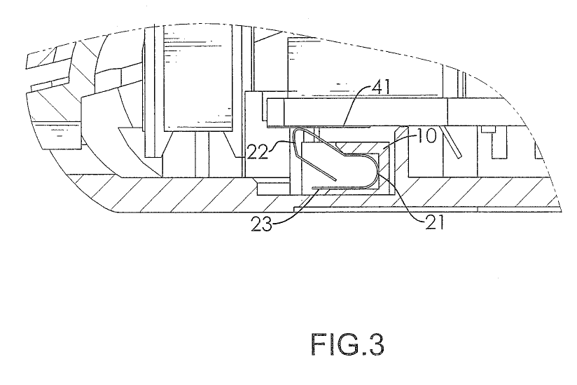

With further reference to FIG. 3, the printed circuit board (40) is mounted on the base (31), located above the insulating base (10) within the computer peripheral device, electrically contact to the first ends of the conductive terminals (20) and may have a plurality of signal contacts (41). The signal contacts (41) are formed on a bottom surface of the printed circuit board (40) and respectively abut the contact portions (22) of the conductive terminals (20). Since the contact portions (22) protrude out from the insulating base (10) and the conductive terminals (20) are metallic and has a little elasticity, therefore the contact portions (22) can tightly contact the signal contacts (41) when the printed circuit board (40) is mounted on the base (30).

The cover (50) is mounted on the base (30) and covers the printed circuit board (40) and the electrical connector (1).

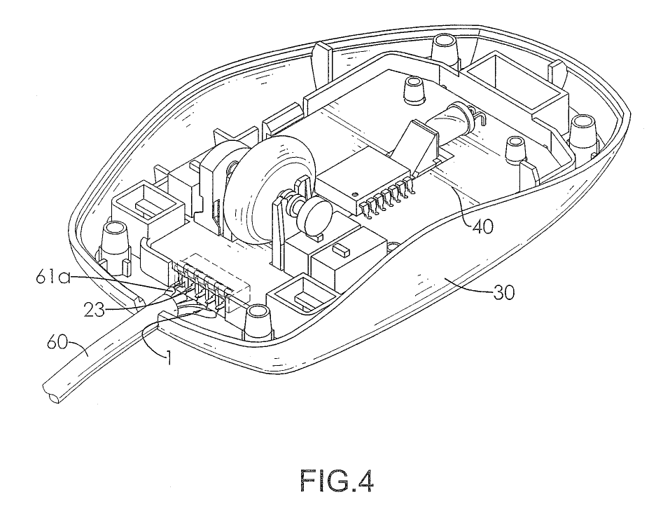

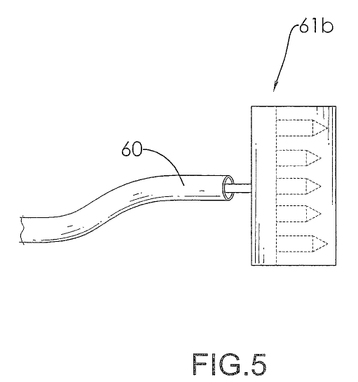

With further reference to FIGS. 4, since the printed circuit board (40) securely connects with the electrical connector (1), the second ends of the conductive terminals (20) may electrically couple to a cable (60) of the computer peripheral device. The cable (60) then electrically connects to the printed circuit board (40) via the conductive terminals (20) to transmit signals. The cable (60) may have a plurality of leads (61a) extending from an end of the cable (60) and the pin portions (23) are for being respectively soldered to the leads (61a) of the cable (60). With further reference to FIG. 5, the cable (60) may have a plug (61b) having a plurality of pins respectively corresponding to the pin portions (23).

In conclusion, the electrical connector (1) facilitates the connection between the printed circuit board (40) and the cable (60) and has advantages of low cost and assembling time-saving and may be able to be applied in automation manufacturing to increase productivity of computer peripheral devices.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An electrical connector of a computer peripheral device, comprising:
an insulating base having
a side; and
a plurality of slots spaced along the side of the insulating base and each of the slots having a conductive terminal;
wherein each of the conductive terminal has
a first end protruding up from the insulating base for electrically contact to a printed circuit board which is located above the insulating base within the computer peripheral device; and
a second end extending away from the insulating base for electrically coupling to a cable of the computer peripheral device.

2. The electrical connector as claimed in claim 1, wherein each conductive terminal is bent and has
a mounting portion being mounted in a corresponding slot of the insulating base;
a contact portion being formed on and extending up from a top end of the mounting portion and protruding out from the insulating base and being implemented as the first end of the conductive terminal; and
a pin portion being formed on and extending forward from a bottom end of the mounting portion under the contact portion and being implemented as the second end of the conductive terminal.

3. The electrical connector as claimed in claim 1, wherein
the second ends of the conductive terminals are for connecting a plug of the cable of the computer peripheral device; and
the plug has a plurality of pins respectively corresponding to the second ends of the conductive terminals.

4. The electrical connector as claimed in claim 1, wherein
the second ends of the conductive terminals are for connecting the cable of the computer peripheral device;
the cable has a plurality of leads extending from an end of the cable; and
the second ends are for being respectively soldered to the leads of the cable.

5. The electrical connector as claimed in claim 2, wherein
the pin portions of the conductive terminals are for connecting a plug of the cable of the computer peripheral device; and
the plug has a plurality of pins respectively corresponding to the pin portions of the conductive terminals.

6. The electrical connector as claimed in claim 2, wherein
the pin portions of the conductive terminals are for connecting the cable of the computer peripheral device;
the cable has a plurality of leads extending from an end of the cable; and
the pin portions are for being respectively soldered to the leads of the cable.
